(19) United States
(12) Patent Application Publication
(10) Pub. No.: US 2007/0255755 A1
(43) Pub. Date: Nov. 1, 2007

(54) Video search engine using joint categorization of video clips and queries based on multiple modalities

(75) Inventors: Ruofei Zhang, Sunnyvale, CA (US); Ramesh R. Sarukkai, Union City, CA (US); Jyh-Herng Chow, San Jose, CA (US); Wei Dai, Sunnyvale, CA (US)

Correspondence Address: THELEN REID BROWN RAYSMAN & STEINER LLP, PO BOX 1510, 875 Third Avenue, 8th Floor, NEW YORK, NY, 10150-1510, US

(73) Assignee: Yahoo! Inc.

(21) Appl. No.: 11/415,838

(22) Filed: May 1, 2006

(51) Int. Cl. G06F 7/00

(52) U.S. Cl. 707/104.1

(57) ABSTRACT

A method comprises generating a first classification model, e.g., metadata-based, for determining whether a video belongs to a category; generating a second classification model, e.g., content-based, for determining whether the video belongs to a category, the first classification model and second classification model being based on different modalities; and generating a fusion model that blends the categorization results of the models. Each classification model may classify the video to multiple categories. During operation, a method obtains a video; uses the first classification model, the second classification model and the fusion model to determine whether the video belongs to a category; and indexes the video in a video index. The method may enable selection of a category corresponding to the video search results. The category may be identified based on a query profile, which may be learned from users' query logs or popular queries and click history.

### TECHNICAL FIELD

This invention relates generally to search engines, and more particularly provides a video search engine that uses joint categorization of video clips and queries based on multiple modalities.

### BACKGROUND

Internet content is vast and distributed widely across many locations. To identify content of interest, a search engine and/or navigator is required for meaningful retrieval of information.

There are numerous search engines and navigators capable of searching for specific Internet content. Current search engines and navigators are designed to search for text within web pages or other Internet files. A search engine locates and stores the location of information and various descriptions of the information in a searchable index.

A search engine may rely upon content providers to establish the location of the content and descriptive search terms to enable users of the search engine to find the content. Alternatively, the search engine registration process may be automated. A content provider places one or more metatags into a web page or other content. Each metatag may contain keywords that a search engine can use to index the page.

To search for Internet content, a search engine may use a web crawler. The web crawler automatically crawls through web pages following every link from one web page to other web pages until all links are exhausted. As the web crawler crawls through web pages, the web crawler correlates descriptive tags on each web page with the location of the page to construct a searchable database.

Lately, video and graphic content, being more content-rich, is becoming a more common and preferred content form. As with text and files, the vast amount of video and graphic content is distributed widely across many locations, creating the need for a video search engine. However, video and graphic content does not lend itself to easy searching techniques because video and graphics often do not contain text that is easily searchable by currently available search engines. Further, since there is no uniform format for identifying and describing a video or a graphic, currently available search engines and browsers are ineffective at meaningful indexing and meaningful retrieval in response to a search query.

Compared with already successful web page search engine technology, video search engine technology is still in its infant stage. Content-based multimedia retrieval (CBMR) has been under intensive research for more than a decade and a large number of features and similarity metrics have been proposed. However, the success of CBMR is rather limited. Accordingly, systems and methods capable of indexing video content and searching vast video databases are needed.

### SUMMARY

One embodiment of the present invention may include a video search engine. Another embodiment of the present invention may include a standalone application for video classification tasks in other video database applications (e.g., entertainment, archiving, museums, surveillance video monitoring, etc.). Other embodiments are also possible.

To boost search relevance of a large scale video search engine on the Internet, a specialized video categorization system combining multiple classifiers based on different modalities (e.g., text, audio, video, image, etc.) is provided. Using the different modalities, a video index is generated. In one embodiment, a specialized video categorization system combines classifiers based on both metadata and content features. Different video categorization learning techniques, including Naive Bayes classifier with mixture of multinomials, Maximum Entropy classifier, and/or a Support Vector Machine classifier, may be used to develop the video categorization learning function.

Further, by studying query logs, it is notable that most users look for video clips falling in specific categories (e.g., news, movies, music, religion, educational, sports, etc.), but that users typically input only a few query words. In fact, it is notable that more than 90% of queries contain less than three words. For example, users searching for “hurricane katrina” typically desire news video clips about the recent hurricane Katrina, instead of education videos about the generation of hurricanes instructed by a person whose name happens to be Katrina. Similarly, users searching for “Madonna” are more likely interested in music videos of the pop star Madonna, instead of some funny videos of a person whose name happens to be Madonna. By learning query and clicking history, a query profile generation technique can be applied to query categorization.

In one embodiment, the system integrates online query categorization with offline video categorization to generate search results. In another embodiment, the system uses only video categorization without query profiling techniques. In one embodiment, the system enables the user to select from various categories to refine the search results. In certain embodiments, joint categorization of queries and videos proves to boost video search relevance and user search experience.

In one embodiment, the present invention provides a method comprising generating one classification model for determining whether a video clip belongs to a category using one modality; generating a second classification model for determining whether the video clip belongs to a category using another modality, the two modalities used being different; and generating a fusion model that uses the results of the first classification model and the second classification model for determining whether the video clip belongs to the category. The first classification model may include a metadata-based classification model. The second classification model may include a content-based classification model. The generating the second classification model may include extracting a keyframe from the video clip and extracting features from the keyframe. Each classification model may be generated by using a machine learning technology, such as Support Vector Machine.

In another embodiment, the present invention provides a system comprising a first learning engine for generating a first classification model to determine whether a video clip belongs to a category; a second learning engine for generating a second classification model to determine whether the video clip belongs to a category, the first classification model being based on a different modality than the second classification model; and a third learning engine for generating a fusion model that uses the results of the first classification model and the second classification model to determine whether the video clip belongs to a category. The first classification model may be based on available metadata. The second classification model may be based on content features of the video clip. The system may further comprise a video analysis component for extracting a keyframe from the video clip; and a feature extraction component for extracting features from the keyframe. Each of the first, second and third learning engines may use a statistical pattern classification technology, such as Support Vector Machine.

In yet another embodiment, the present invention provides a method comprising obtaining a video clip; using a first classification model to determine whether the video clip belongs to a category; using a second classification model to determine whether the video clip belongs to a category, the first classification model being based on a different modality than the second classification model; using a fusion model that uses the results of the first classification model and the second classification model to determine whether the video clip belongs to a category; and indexing the video clips based on the result of the fusion model in a video index. The first classification model may include a metadata-based classification model. The second classification model may include a content-based classification model. The method may further comprise extracting a keyframe from the video clip and extracting features from the keyframe. The method may further comprise generating video search results in response to a query classification method and enabling selection of a category corresponding to the query classification results. The category may be identified from the possible categories of a subset of the query classification results. The category may be identified based on a query profile associated with the query using a learning method. The query profiles may be determined based on users' queries and click history. The query profiles may be determined based on popular queries and click history.

In another embodiment, the present invention provides a system comprising a first classification model for determining whether a video clip belongs to a category; a second classification model for determining whether the video clip belongs to a category, the first classification model being based on a different modality than the second classification model; a fusion model that uses the results of the first classification model and the second classification model for determining whether the video clip belongs to a category; and an index building component for indexing the video clips based on the result of the fusion model in a video index. The first classification model may include a metadata-based classification model. The second classification model may include a content-based classification model. The system may further comprise a video analysis component for extracting a keyframe from the video clip; and a feature extraction component for extracting features from the keyframe. The system may further comprise a video search engine for generating video search results in response to a query and enabling selection of a category corresponding to the query classification results. The video search engine may identify the category from the possible categories of a subset of the query classification results. The video search engine may identify the category based on a query profile associated with the query using a learning method. The video search engine may determine the query profiles based on users' personal queries and click history. The video search engine may determine the query profiles based on popular queries and click history.

### BRIEF DESCRIPTION OF THE DRAWINGS

FIG. 1 is a block diagram of a video classification training system in accordance with an embodiment of the present invention.

FIG. 2 is a block diagram illustrating details of a video classification and searching system, in accordance with an embodiment of the present invention.

FIGS. 3A and 3B are screen-shots of example search results to a query, in accordance with an embodiment of the present invention.

FIG. 4 is a screen-shot of example search results to the search term “Tom Cruise” limited to the category of news video clips, in accordance with an embodiment of the present invention.

FIG. 5 is a block diagram illustrating details of a computer system.

FIG. 6 is flowchart illustrating a method of training a video search engine, in accordance with an embodiment of the present invention.

FIG. 7 is a flowchart illustrating a method of indexing and searching a video database using dual modalities and possibly query profiling, in accordance with an embodiment of the present invention.

FIG. 8 is a block diagram illustrating details of a method of generating a query profile, possibly by the query profile generation learning component, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

One embodiment of the present invention may include a video search engine: Another embodiment of the present invention may include a standalone application for video classification tasks in other video database applications (e.g., entertainment, archiving, museums, surveillance video monitoring, etc.). Other embodiments are also possible.

To boost search relevance of a large scale video search engine on the Internet, a specialized video categorization framework combines multiple classifiers based on different modalities (e.g., text, audio, video, image, etc.) is developed. Using the different modalities, a video index is generated. In one embodiment, a specialized video categorization framework combines multiple classifiers based on both metadata and content features. Different video categorization learning techniques, including Naive Bayes classifier with mixture of multinomials, Maximum Entropy classifier, and/or a Support Vector Machine classifier, may be used to develop the video categorization learning function.

Further, by studying query logs, it is notable that most users look for video clips falling in specific categories (e.g., news, movies, music, religion, educational, sports, etc.), but that users typically input only a few query words. In fact, it is notable that more than 90% of queries contain less than three words. For example, users searching for “hurricane katrina” typically desire news video clips about the recent hurricane Katrina, instead of education video clips about the generation of hurricanes instructed by a person whose name happens to be Katrina. Similarly, users searching for “Madonna” are more likely interested in music videos of the artist Madonna, instead of some funny videos of a person whose name happens to be Madonna. By learning query and clicking history, a query profile generation technique can be applied to query categorization.

In one embodiment, the system integrates online query categorization with offline video categorization to generate search results. In another embodiment, the system uses only video categorization without query profiling techniques. In one embodiment, the system enables the user to select from various categories to refine the search results. In a certain embodiment, joint categorization of queries and videos proves to boost video search relevance and user search experience.

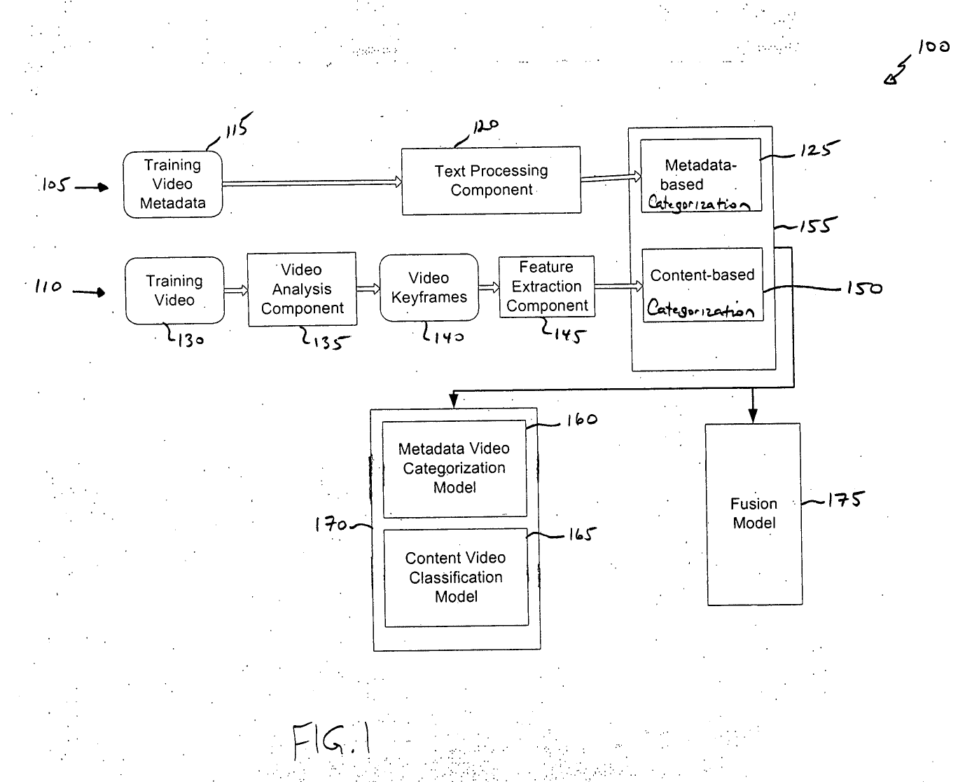

FIG. 1 is a block diagram illustrating details of a video search engine training system 100, in accordance with an embodiment of the present invention. Video search engine training system 100 applies two modalities for training, namely, modality 105 using metadata-based analysis and modality 110 using content-based analysis. Using metadata-based modality 105 and content-based modality 110, the video search training system 100 generates video categorization models for categorizing video clips into a variety of categories, e.g., news, music, movies, educational, sports, religion, professional, etc. In one embodiment, a video categorization model may be generated for each category. That way, a video clip may fall into multiple categories. The metadata-based classification model (e.g., a Support Vector Machine (SVM) based model) 125 and content-based classification model (e.g., a SVM based model) 150 together form an example dual modality learning machine 155.

Metadata-based modality 105 begins by obtaining training video metadata 115 (e.g., author information, tag information, domain information, title information, referring URL, abstract, keyword, description, etc.) for a training set of videos. The training video metadata 115 for each video clip can be obtained from the video file itself or from various Internet sites linking to the video clip. A text processing component 120 generates text information from the video metadata 115, and forwards the text information to a metadata-based SVM 125 (although other categorization function learning engines such as Naive Bayes or Maximum Entropy may alternatively be used). Using the text information, metadata-based SVM 125 generates a metadata-based video categorization model 160, which can be used to categorize video metadata on the Internet. The number of features may be large (e.g., dozens of thousands). To improve time/space performance and reduce the over-fitting problem, feature selection methods (such as mutual information) may be used and the optimal number of features determined by cross validation may be selected.

Content-based modality 110 begins by obtaining the training set of videos 130 (e.g., videos obtained by a web crawler). A video analysis component 135 locates representative video keyframes 140, possibly using techniques as described in the article, entitled “Key frame selection to Represent a Video” by F. Defaux, and published in IEEE International Conference on Image Processing in year 2000. A feature extraction component 145 extracts features (e.g., spatial color distributions, texture, facial recognition, object recognition, shape features, and/or the like) from the video keyframes 140 and forwards the extracted features to a content-based SVM 150 (although other categorization function learning engines such as Naive Bayes or Maximum Entropy may alternatively be used). Using the video keyframes and a predetermined set or determinable set of features, the content-based SVM 150 generates a content-based video classification model 165, which can be used to categorize video clips based on their content on the Internet.

In one embodiment, the feature extraction component 145 extracts color distribution of frames. To represent the spatial color distribution of frames in the video, feature extraction component 145 computes color autocorrelogorams. Color autocorrelograms compute a histogram of color pairs in different distances. It can be defined as

$${Γ}_{{c}_{i} , {c}_{i}}^{( k )} ( I ) {=}^{△} \vert \{ {p}_{1} ε {I}_{{c}_{i}} , {p}_{2} ε {I}_{{c}_{i}} \vert \vert {p}_{1} - {p}_{2} \vert = k \} \vert$$

where |p1−p2| is the L1 distance between pixel p₁ and p₂ whose color is in bin cᵢ.

In another embodiment, the feature extraction component 145 extracts texture feature for frames. To represent the texture feature, the feature extraction component uniformly partitions each frame into blocks, and computes Gabor wavelet coefficients by a filter bank for each block. A two dimensional Gabor function g(x,y) and its Fourier transform can be written as:

$$g ( x , y ) = ( \frac{1}{2 {πσ}_{x} {σ}_{y}} ) exp [ - \frac{1}{2} ( \frac{{x}^{2}}{{σ}_{x}^{2}} + \frac{{y}^{2}}{{σ}_{y}^{2}} ) + 2 π j W x ]$$

$$G ( u , v ) = exp \{ - \frac{1}{2} [ \frac{{( u - W )}^{2}}{{σ}_{u}^{2}} + \frac{{v}^{2}}{{σ}_{v}^{2}} ] \}$$

where
σᵤ=1/2πσ,σᵥ=1/2πσ_{y} and W
denotes the upper center frequency of interest. Based on the mother Gabor wavelet g(x,y), a self-similar filter dictionary can be obtained by appropriate dilations and rotations of g(x,y) through the generating function:
gₘₙ(x,y)=a^{-m}G(x′,y′), a>1, m,n=integer
x′=a^{-m}(x cos θ+y sin θ), and y′=a^{-m}(−x sin θ+y cos θ)
where
θ=nπ/K and K| is the total number of orientations. The scalar factor a^{-m} is meant to measure the energy that is independent of m, m=0, 1, . . . , S−1. By using the filter response for S scalars and K orientations, the feature extraction component 145 computes a vector for each block which describes the texture features. The feature extraction component 145 combines the color autocorrelograms and Gabor wavelet coefficients together to compose the content features for frames of one video clip.

For metadata-based and content-based training, the training set of videos may include videos manually classified by domain experts to predefined categories (such as News, Music, Movie, Finance, and Funny Video). For metadata, standard text processing may be performed, including upper-lower case conversion, stopword removal, phrase detection, and stemming.

Different classification models (e.g., Naive Bayes, Maximum Entropy, Support Vector Machine, etc.) may be applied to the metadata obtained from the training set of videos to generate the metadata video categorization model 160. Similarly, different classification models (e.g., Naive Bayes, Maximum Entropy, Support Vector Machine, etc.) may be applied to the video features obtained from the training set of videos to generate the content-based video classification model 165. A discussion of the Naive Bayes, Maximum Entropy and Support Vector Machine classifiers are described below.

Naive Bayes

Naive Bayes is a well-studied classification technique. Despite strong independent assumptions, its attractiveness comes from low computational cost, relatively low memory consumption, the ability to handle heterogeneous features and multiple categories.

In video categorization based on text data, the distribution of words for each text field of video's metadata is modeled as a multinomial. A text field is treated as a sequence of words, and it is assumed that each word position is generated independently of every other. And, therefore, each category has a fixed set of multinomial parameters. The parameter vector for a category c is
\vec{θ}_{c}={θ_{c1},θ_{c2}, . . . ,θ_{cn}}|
where n is the size of the vocabulary, Σᵢθ_{ci}=1 and θ_{ci} is the probability that word i occurs in that category. The likelihood of a video passage is a product of the parameters of the words that appear in the passage:

$$p ( o \vert {\vec{θ}}_{c} ) = \frac{( {\sum }_{i} {\sum }_{k} {w}_{k} {t}_{i , k} ) !}{{\prod }_{i , k} ( {w}_{i} {t}_{i , k} ) !} {\prod }_{i , k} {( {θ}_{ci} )}^{{w}_{k} {t}_{i , k}} \vert$$

where t_{i,k} is the frequency count of word i in the field k, whose weight is wₖ, of video object o. Filed importance weight wₖ is taken into consideration because different fields of video metadata have different contribution to describe the semantics of video clips on the aspects of precision and discrimination capability. This adjustment of model improves video categorization accuracy. By assigning a prior distribution over the set of classes, p(\vec{θ}_{c}), the minimum-error categorization rule which selects the category with the largest posterior probability can be derived; it is defined as,

$$\begin{matrix}l ( o ) = arg {max}_{c} [ log p ( {\vec{θ}}_{c} ) + {\sum }_{\cdot } {\sum }_{\cdot } {w}_{k} {t}_{i , k} log {θ}_{ci} ] \vert \\ = arg {max}_{c} [ {b}_{c} + {\sum }_{i} {\sum }_{k} {w}_{k} {t}_{i , k} {z}_{ci} ]\end{matrix}$$

where b_{c} is the threshold term and z_{ci} is the category c weight for word i. These values are natural parameters for the decision boundary. The parameters \vec{θ}_{c}| are estimated from the training data. This is done in our system by selecting a Dirichlet prior and taking the expectation of the parameter with respect to the posterior. This gives a simple form for the estimate of the multinomial parameter, which involves the field-weighted number of times word i appears in the passages of videos belonging to class c (ΣₖwₖN_{k,c}, where N_{i,k,c} is the number of times word i appears in the field k of video clips in category c, divided by the total field-weighted number of word occurrences in field k of class c(ΣₖwₖN_{k,c}). For word i, a prior adds in αᵢ imagined occurrences so that the estimate is a smoothed version of the maximum likelihood estimate:

$${\vec{θ}}_{ci} = \frac{{\sum }_{k} {w}_{k} {N}_{i , k , c} + {α}_{i}}{{\sum }_{k} {w}_{k} {N}_{k , c} + α} \vert$$

where α denotes the sum of the αᵢ. While αᵢ can be set differently for each word, we follow common practice by setting αᵢ=1 for all words.

In video classification based on visual content, each feature dimension v_{d} is modeled as a Gaussian in category c,

$$p ( {v}_{d} \vert c ) = \frac{1}{\sqrt{2 π} {σ}_{c , d}} exp [ - \frac{{( {v}_{d} - {m}_{c , d} )}^{2}}{2 {σ}_{c , d}^{2}} ] \vert$$

where m_{c,d} is the mean value of the v_{d}, and σ_{c,d} is the standard deviation of the v_{d} in category c, respectively. Applying a maximum-likelihood method on the training videos for each category c, the following unbiased estimations of the mean m_{c,d} and the standard deviation σ_{c,d} are obtained:

$${\hat{m}}_{c , d} = \frac{1}{{U}_{c}} {\sum }_{i ∈ c} {v}_{i , d} \vert \\ and$$

$${\hat{σ}}_{c , d}^{2} = \frac{1}{{U}_{c} - 1} {\sum }_{i ∈ c} {( {v}_{i , d} - {\hat{m}}_{c , d} )}^{2}$$

$${v}_{c \vert}$$

where v_{i,d} denotes the d^{th} dimension of the feature vector vᵢ and U_{c} is the number of video clips belonging to category c. Giving the assumption that the visual features are conditional independent for category c, categorization may be performed based on the similar formula to the minimum-error categorization rule provided above with reference to text classification.
Maximum Entropy Classifier

Maximum entropy is a general technique for estimating probability distribution from data. The overriding principle in maximum entropy is that, when nothing is known, the distribution should be as uniform as possible, that is, have maximal entropy. A maximum entropy classifier estimates the conditional distribution of the category label given a video clip with some constraints set by using the training data. Each constraint expresses a characteristic of the training data that should also be present in the learned distribution. In a generalized form, each video o in a category c is represented by
\vec{f}(o,c)={f₁(o,c),f₂(o,c), . . . ,fₙ(o,c)}.|
Maximum entropy allows a restriction of the model distribution to have the same expected value for feature fᵢ(o,c) as seen in the training data. Thus, the learned conditional distribution p(c|o) should have the property:

$$\frac{1}{U} {\sum }_{o} {f}_{i} ( o , c ( o ) ) = {\sum }_{o} p ( o ) {\sum }_{c} p ( c \vert o ) {f}_{i} ( o , c ) \vert$$

where U is the number of training videos. The video distribution p(o) is unknown. To avoid modeling it, training data is used without category labels as an approximation to the video distribution, and enforce the constraint:

$$\frac{1}{U} {\sum }_{o} {f}_{i} ( o , c ( o ) ) = \frac{1}{U} {\sum }_{o} {\sum }_{c} p ( c \vert o ) {f}_{i} ( o , c ) \vert$$

The feature fᵢ(o, c) is either the normalized word counts for metadata or the visual feature extracted from the video frames. For each feature, its expected value is measured over the training data and is taken to be a constraint for the model distribution.

When constraints are estimated in this fashion, it is likely that a unique distribution that has maximum entropy exists. Moreover, it can be shown that the distribution is always of the exponential form:

$$p ( c \vert o ) = \frac{1}{Z ( o )} exp ( {\sum }_{i} {λ}_{i} {f}_{i} ( o , c ) ) \vert$$

where λᵢ is a parameter to be estimated and Z(o) is simply the normalizing factor to ensure a proper probability:

$$Z ( o ) = {\sum }_{c} exp ( {\sum }_{i} {λ}_{i} {f}_{i} ( o , c ) )$$

The form of maximum entropy classifier is a multicategory generalized form of logistic regression classifier. When the constraints are estimated from labeled training data, the solution to the maximum entropy problem is also the solution to a dual maximum likelihood problem for models of the same exponential form. The attractiveness of this model is that the likelihood surface is convex, having a single global maximum and no local maxima. We perform a hill-climbing algorithm in likelihood space to find the global maximum. To reduce the overfitting, a Gaussian prior is introduced on the model with the mean at zero and a diagonal covariance matrix. This prior favors feature weightings that are closer to zero, that is, less extreme. The prior probability of the model is the product over the Gaussian of each feature value λᵢ with variance σᵢ².

$$p ( Λ ) = {\prod }_{i} \frac{1}{\sqrt{2 π {σ}^{2}}} exp ( \frac{- {λ}_{i}^{2}}{2 {σ}_{i}^{2}} )$$

It has been shown that introducing a Gaussian prior on each λᵢ improves performance for language modeling tasks when sparse data causes overfitting. Similar improvements are also demonstrated in our experiments.
Support Vector Machine Classifier

Unlike the above generative models, a Support Vector Machine (SVM) is a binary categorization method based on a discriminative model which implements the structural risk minimization (SRM) principle. It creates a classifier with a minimized Vapnik-Chervonenkis (VC) dimension. SVM minimizes an upper bound on the generalization error rate. The attractiveness of SVM comes from its good generalization performance on pattern classification problems without incorporating problem domain knowledge. Video categorization may be formed as an ensemble of binary categorization problems with one SVM classifier for each category. For a binary categorization problem, if the two categories are linearly separable, the hyperplane that does the separation can be easily calculated by \vec{w}^{T}o+b=0,| where \vec{w} is a weight vector, and b is a bias. The goal of SVM is to find the parameters \vec{w} and b for the optimal hyperplane to maximize the distance between the hyperplane and the closest data point:
(\vec{w}^{T}o+b)c≧1
If the two categories are non-linearly separable, the input vectors should be nonlinearly mapped to a high dimensional feature space by an inner-product kernel function

K(\vec{x}: \vec{x}ᵢ).| Here, the feature space is a conventional name in SVM literature, which is different with the feature used to represent videos. Typical kernel functions are polynomial K(\vec{x}, \vec{x}ᵢ)=(\vec{x}^{T}\vec{x}ᵢ+1)^{p},| radial basis

$$K ( \vec{x} , {\vec{x}}_{i} ) = exp ( - \frac{1}{2 {σ}^{2}} {‖ \vec{x} - {\vec{x}}_{i} ‖}^{2} ) , \vert$$

and sigmoid K(\vec{x}, \vec{x}ᵢ)=tan h(a₀\vec{x}^{T}\vec{x}ᵢ+a₁). An optimal hyperplane is constructed for separating the data in the high dimensional feature space. The hyperplane is optimal in the sense of being a maximal margin classifier with respect to the training data.

In its standard formulation, SVM only outputs a prediction +1 or −1, without any associated measure of confidence. In one embodiment, we modify the SVM, to output posterior category probabilities. This modification retains the powerful generalization ability of SVM and paves the way to wide extensions, such as integrate within a probabilistic framework. In one embodiment, the system uses a probabilistic version of the SVM (PSVM) similar to the one proposed by K. Yu et al in paper “Knowing a Tree From the Forest: Art Image Retrieval Using a Society of Profiles”, published in ACM MM Multimedia 2003 Proceedings, Berkeley, Calif., November 2003. Here, the probability of membership in category y,y ∈ {+1, 1}| is given by:

$$p ( y \vert o ) = \frac{1}{1 + exp ( yA \vert {\vec{w}}^{T} o + b \vert )}$$

where A is the parameter to determine the slope of the sigmoid function. This modified SVM retains the same decision boundary as defined by \vec{w}^{T}o+b=0, yet allows easy computation of posterior category probabilities. The output of PSVM can be compared with the output of other generative model based categorization methods. In one embodiment, the system may use a cross validation scheme to set the parameter A for each category. In one embodiment, a PSVM classifier may be used for both metadata and content feature of training video clips for each category.

After constructing classifiers 125 and 150 based on the metadata and content features of videos, a fusion model 175 may be generated to combine the categorization outputs from the two modalities to boost accuracy. However, the problem of selecting most effective classifiers and determining the optimal combination weights naturally follows. For some categories (e.g., news video, music video), metadata-based classifiers may have better accuracy than content-based classifiers; while for other categories (e.g., adult video) content-based feature classifiers may work better. To take advantage of this, a voting-based category-dependent combination scheme is developed to provide a fused output. Specifically, each video can have multiple labels (e.g., a financial news video belongs both to news category and finance category). Hence, a binary classifier for each category is developed. And in the training phase, a k-fold validation procedure can be implemented to obtain an estimated categorization accuracy a_{i,m} for each category cᵢ by the classifier based on modality m. The combination scheme developed is:

$$p ( {c}_{i} \vert o ) = \frac{{\sum }_{m} {a}_{i , m} {p}_{m} ( {c}_{i} \vert o )}{{\sum }_{m} {a}_{i , m}}$$

The video is assigned to category cᵢ if p(cᵢ|o) is larger than a threshold. a_{i,m} reflects the effectiveness of the modality m to the category cᵢ, while pₘ(cᵢ|o) is the confidence of assigning o to category cᵢ by the modality m based classifier. This scheme is a validation accuracy weighted combination scheme and the strength of the classifiers based on both modalities are integrated, thereby improving the performance of the final categorization recall and precision.

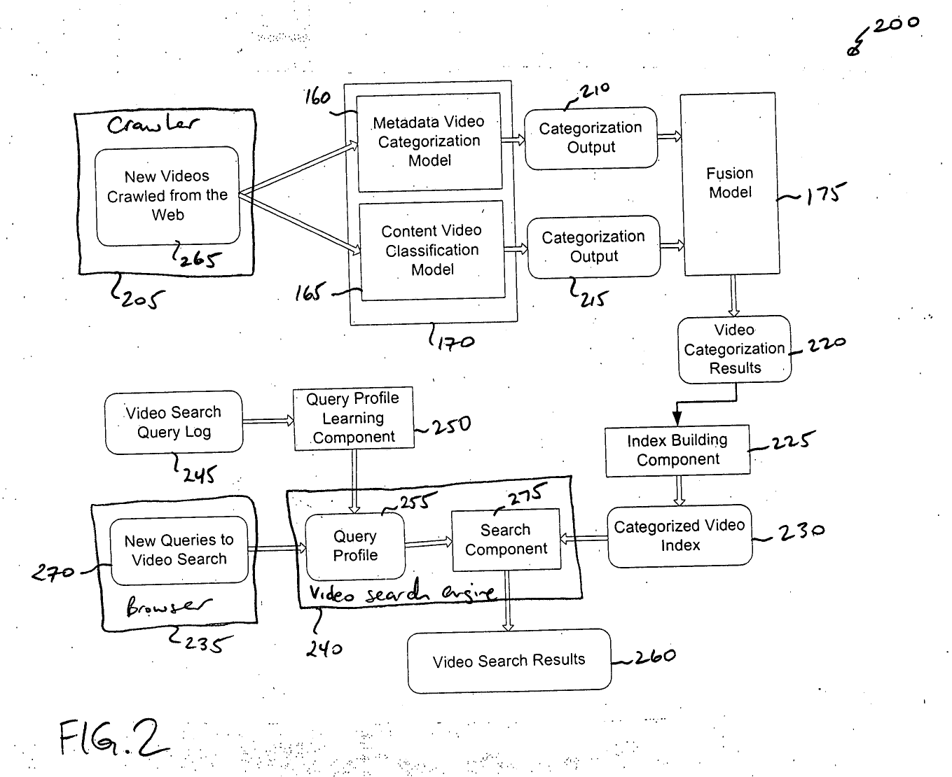

FIG. 2 is a block diagram illustrating a video categorization and search system 200, in accordance with an embodiment of the present invention. Video categorization and search system 200 includes a crawler 205 that obtains new videos 265 offline from the Internet. The crawler 205 forwards a new video 265 of interest to a dual modality categorization model 170, e.g., to the metadata-based categorization model 160 which generates a metadata-based categorization output 210 (identifying the category or categories to which the video belongs) and to the content-based classification model 165 which generates a content-based categorization output 215 (identifying the category or categories to which the video belongs). The fusion model 175 uses the metadata-based categorization output 210 and the content-based categorization output 215 to generate a single categorization result 220 (identifying the category or categories to which the video belongs) for the video of interest. An index building component 225 indexes the video of interest and its categorization into a categorized video index 230.

Users enter a query 270 into a browser 235 to conduct a video search. The browser 270 forwards the query to the video search engine 240, which includes a search component 275 that determines the video search results 260.

In one embodiment, query profiling may not be integrated into the system 200. The search component 275 may obtain the video search results 260 using conventional relevance function techniques, and may enable the user to select from the set of possible categories. For example, if the user enters the query “Tom Cruise,” the search component 275 may gather the video result set, and may enable the user to select from the predefined set of categories (e.g., movie, religion, news, etc). Then, if the user selects a category, the search component 275 may provide a result set from the video clips belonging to that category.

In another embodiment, the video search engine 240 obtains a query profile 255 for the query. Query profile generation may be generated using a video search query log 245 and a query profile learning component 250. The query profile learning component 250 can monitor the clicking habits of users in response to queries to learn the intended categories of the queries. For example, if users entering the query “Tom Cruise” regularly select between news videos and movie video clips, the query profile learning component 250 can profile the query as pertaining to one of news videos and/or movie videos. The search component 275 may enable users to select from those categories to which the query pertains, may factor the query profile into weighting the initial result set, may order the category options based on the query profile, etc.

When the same query is submitted by different users, a typical search engine returns the same result, regardless of who submitted the query. This may be unsuitable for users with different information needs. For example, for the query “apple”, some users may be interested in videos dealing with apple gardening, while other users may want news or financial videos related to Apple Computers. One way to disambiguate the words in a query is to manually associate a small set of categories with the query. However, users are often too impatient to identify the proper categories before submitting queries.

The video search engine 240 (or a separate logging engine) may gather the users' search history, and the query profile learning component 250 may construct a query profile. To construct a query profile, the querying log of each user or all users on the search engine 240 may be analyzed. The query log of all vertical search engines may be analyzed to construct the query profile because users' semantic querying needs are represented similarly for any vertical search. From the log, two matrices, VT and VC, as

TABLE 1
Matrix representation of users' querying log.
(a) Matrix VT

| Video/ | tom | | holly- | foot- | super | touch |
|---|---|---|---|---|---|---|
| Term | cruise | movie | wood | ball | bowl | down |
| V1 | 1 | 1 | 0.8 | 0 | 0 | 0 |
| V2 | 0.3 | 0.8 | 0.6 | 0 | 0 | 0 |
| V3 | 0 | 0 | 0 | 1 | 0 | 1 |
| V4 | 0 | 0 | 0 | 0.62 | 0.7 | 0.3 |

(b) Matrix VC

| Video/Category | Movie | Sport |
|---|---|---|
| V1 | 1 | 0 |
| V2 | 1 | 0 |
| V3 | 0 | 1 |
| V4 | 0 | 1 |

Each cell in Table VT denotes the significance of the term in the description of relevant videos (i.e., V1 to V4) clicked by users, which is computed by the standard information retrieval techniques (TF*IDF). Table VC is generated by web surfers to describe the relationships between the categories and the video clips. What the query profile learning component 250 intends to generate is the query profile matrix QP, which is shown in Table 2.

TABLE 2
Matrix representation of query profile QP.

| Video/ | tom | | holly- | foot- | super | touch |
|---|---|---|---|---|---|---|
| Term | cruise | movie | wood | ball | bowl | down |
| Movie | 0.7 | 1 | 0.9 | 0 | 0 | 0 |
| Sport | 0 | 0 | 0 | 1 | 0.67 | 0.55 |

To learn QP from VT and VC, We apply a method based on linear least square fitting (LLSF), in which QP is computed such that
VT*QP^{T}≅VC|
with the least sum of square errors. Solving the problem by employing Singular Value Decomposition (SVD), the following equation is obtained:
QP=VC^{T}*U*S⁻¹*V^{T}|
where the SVD of VT is VT=U*S*VT; U and V are orthogonal matrices and S is a diagonal matrix.

For each query term, its related categories are predicted by using QP and categorizing it accordingly. Specifically, the similarity between a query vector q and each category vector qp in the query profile QP is computed by the Cosine function. Then, the categories are ranked in descending order of similarities and the top ranked categories are provided to the user for selecting the one as his/her query's context.

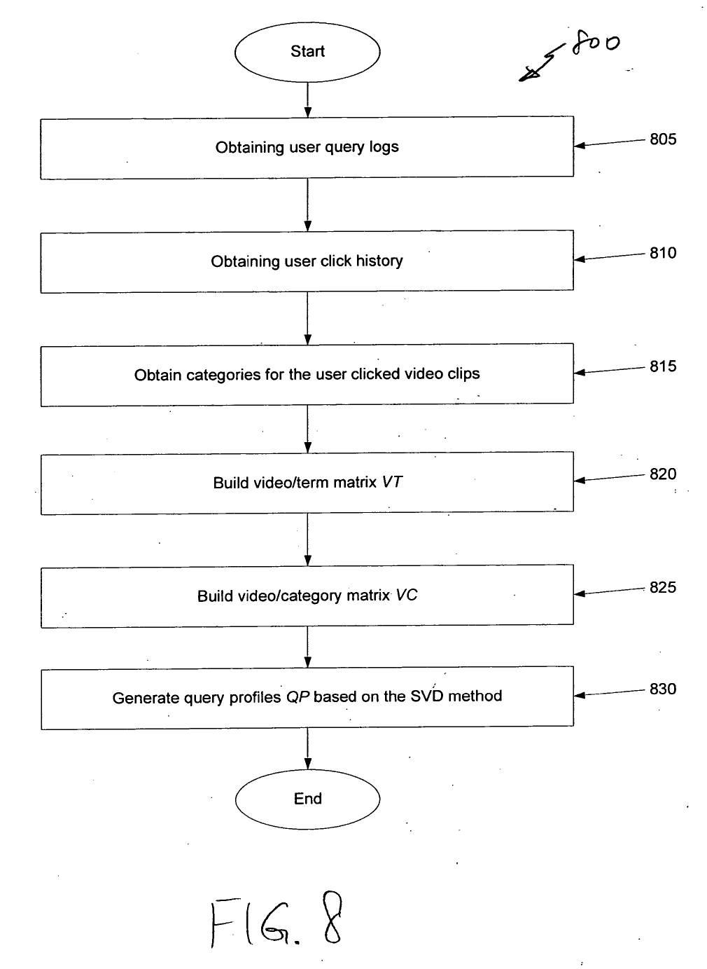

FIG. 8 is a block diagram illustrating details of a method 800 of generating a query profile, possibly by the query profile generation learning component 250, in accordance with an embodiment of the present invention. First, the users' query logs for the video search engine 240 are collected 805. The click history of the users for each query (i.e., a video list) is also collected 810. For each video, the labels of the categories the query belongs to are obtained 815. The category labels may come from the video's metadata or from domain experts' judgments. Then, the video/term matrix VT is built 820 for all videos in the click history and all query words. The video/category matrix VC is also built 825 for each video in the click history. Based on the SVD method described above, the query profile is generated 830 using matrix VT and VC. The query profile may be used to categorize queries online. Method 800 then ends.

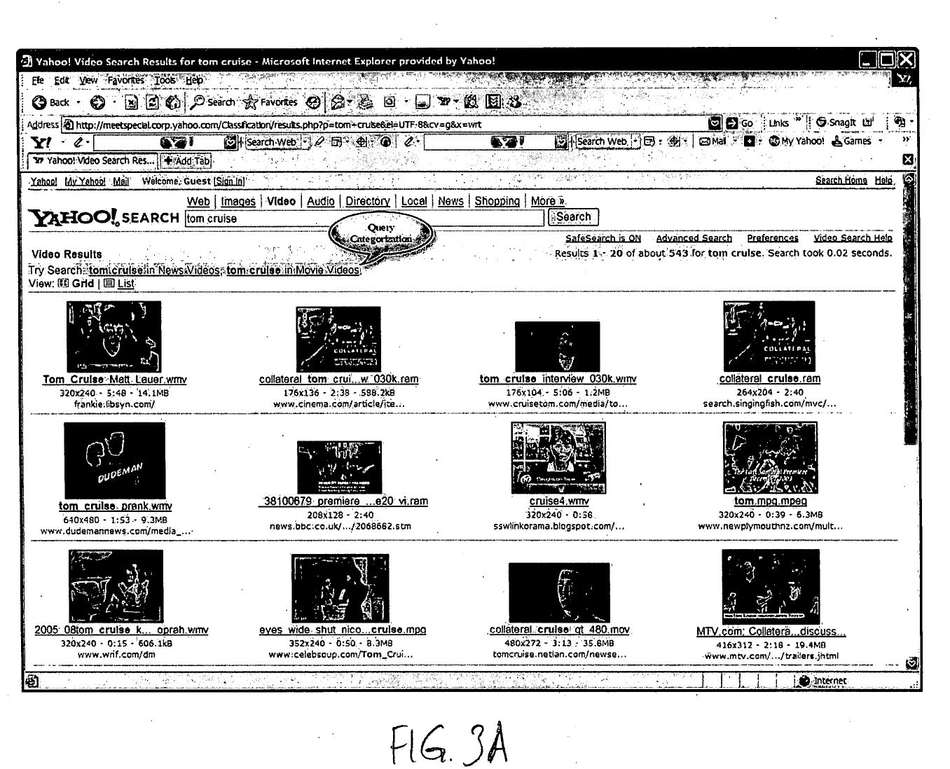

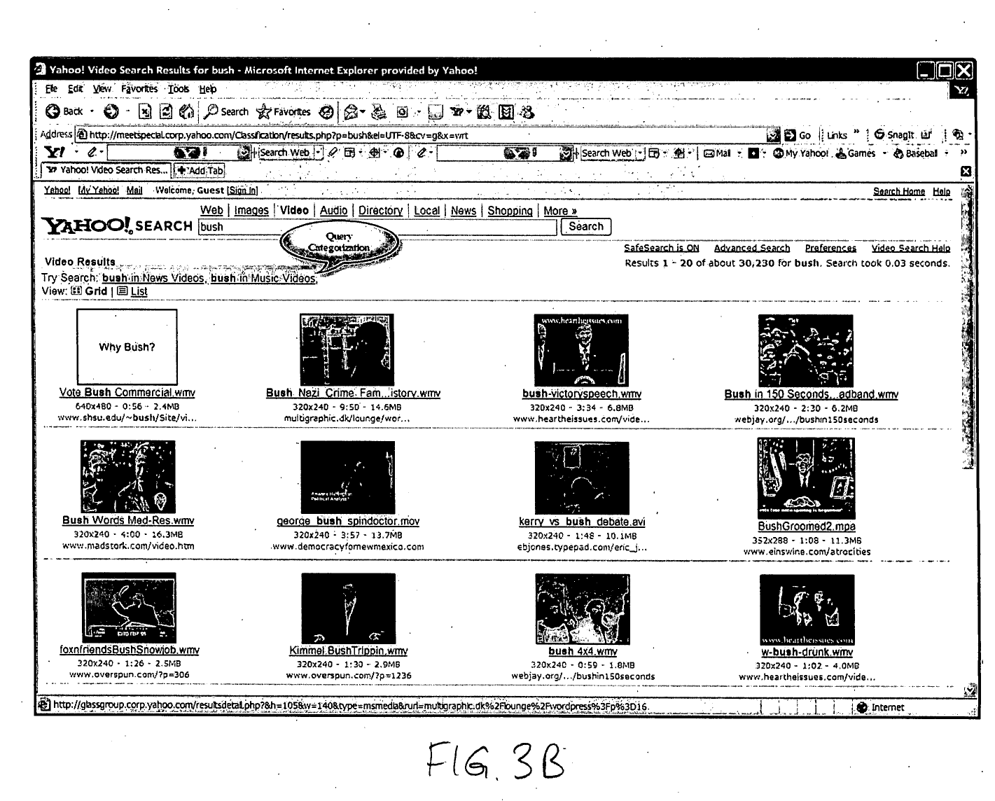

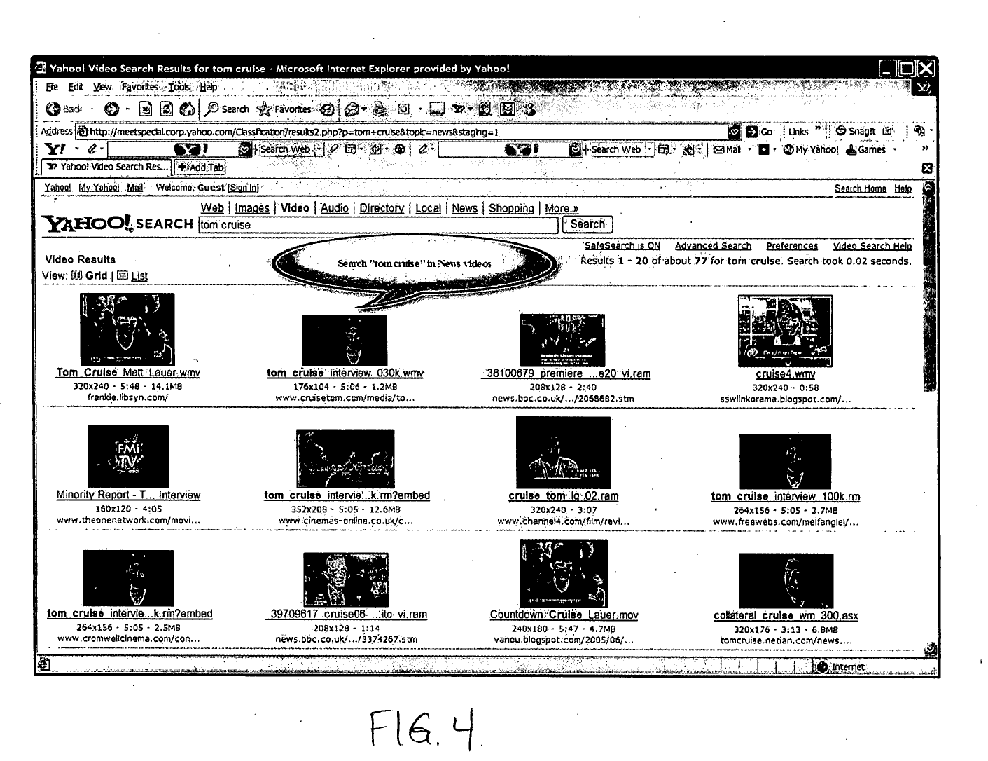

FIG. 3A is example video search results 260 for the query “Tom Cruise.” The search results 260 include the links for selecting from two categories, namely, “tom cruise in News Videos” or “tom cruise in movie videos.” In one embodiment, the search component 275 may identify and return the related categories with the video results retrieved without using the query categorization. In other words, the categories are based on the search results (e.g., listing the categories to which the top 100 videos in the search results belong). In another embodiment, the related categories may be generated based on query categorization (as indicated in FIG. 3A). If the user selects one of the categories, then the search component 275 of the video search engine 275 can refine the results to identify the most relevant videos in the selected category. FIG. 3B is example search results 260 for the query “Bush.” As shown, the video clips are categorized into news videos and music videos. In this example, the categorizations enable separation of topic, since news videos will most likely refer to video clips involving George Bush and music videos will likely refer to video clips of the grunge music group named “Bush” or pop singer named “Kate Bush.” FIG. 4 is example video search results 260 refined in response to user selection of the New Videos category.

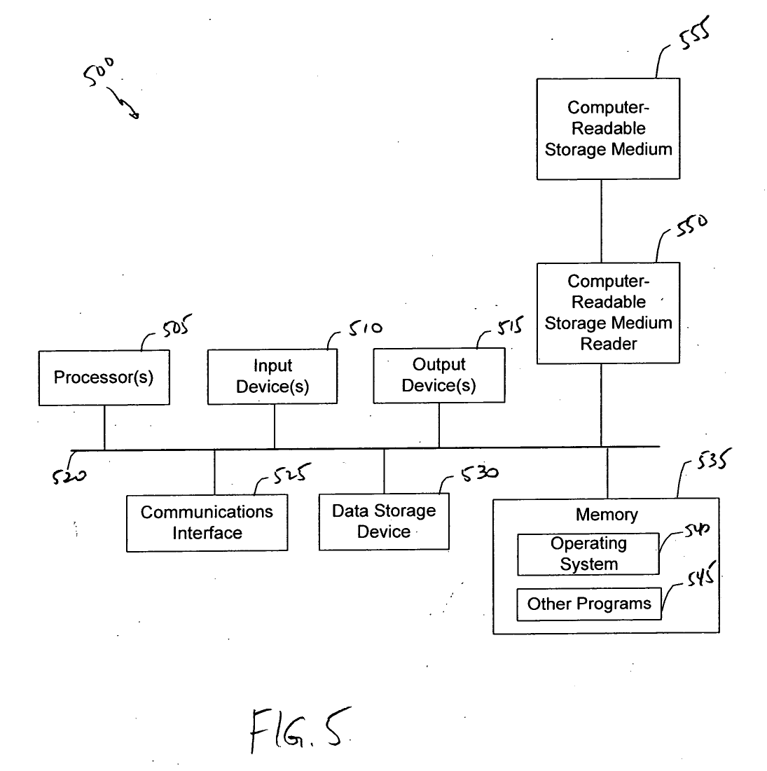

FIG. 5 is a block diagram illustrating details of an example computer system 500, of which system 100 or system 200 may be an instance. Computer system 500 includes a processor 505, such as an Intel Pentium® microprocessor or a Motorola Power PC® microprocessor, coupled to a communications channel 520. The computer system 500 further includes an input device 510 such as a keyboard or mouse, an output device 515 such as a cathode ray tube display, a communications device 525, a data storage device 530 such as a magnetic disk, and memory 535 such as Random-Access Memory (RAM), each coupled to the communications channel 520. The communications interface 525 may be coupled to a network such as the wide-area network commonly referred to as the Internet. One skilled in the art will recognize that, although the data storage device 530 and memory 535 are illustrated as different units, the data storage device 530 and memory 535 can be parts of the same unit, distributed units, virtual memory, etc.

The data storage device 530 and/or memory 535 may store an operating system 540 such as the Microsoft Windows XP, the IBM OS/2 operating system, the MAC OS, or UNIX operating system and/or other programs 545. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art recognizes that the computer system 500 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 550 such as a magnetic disk drive, hard disk drive, magneto-optical reader, CPU, etc. may be coupled to the communications bus 520 for reading a computer-readable storage medium (CRSM) 555 such as a magnetic disk, a hard disk, a magneto-optical disk, RAM, etc. Accordingly, the computer system 500 may receive programs and/or data via the CRSM reader 550. Further, it will be appreciated that the term “memory” herein is intended to cover all data storage media whether permanent or temporary.

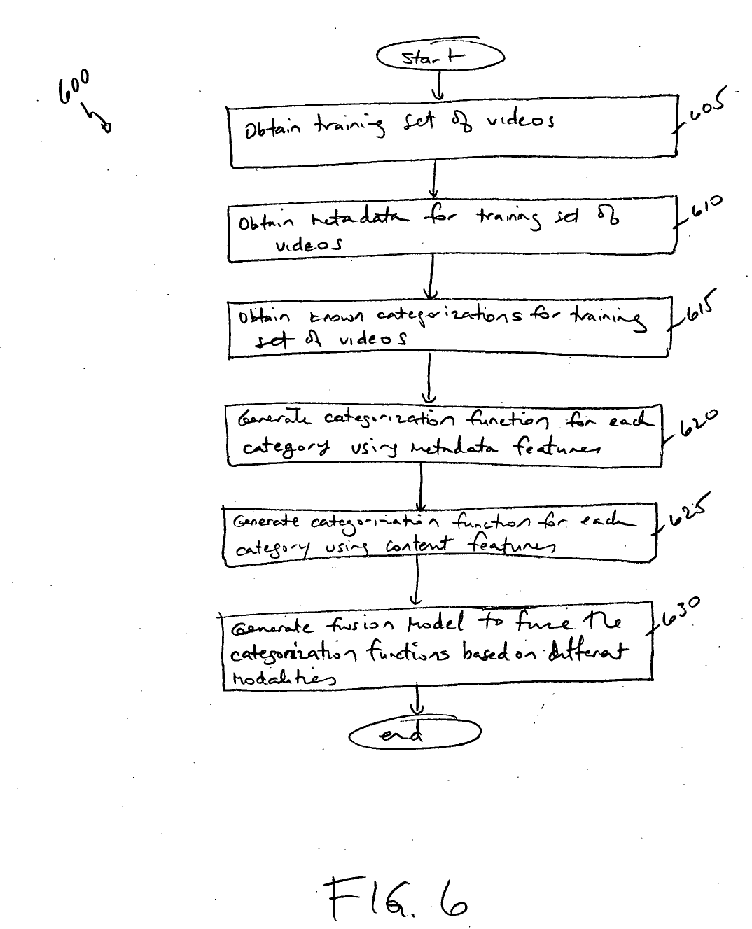

FIG. 6 is flowchart illustrating a method 600 of training the video classification system to be used in a video search engine, in accordance with an embodiment of the present invention. Method 600 begins in step 605 with the obtaining of a training set of video clips, e.g., videos 130. The training set of video clips may be obtained from one or more human subjects and/or a web crawler. In step 610, metadata, e.g., metadata 115, is obtained for the training set of video clips. The metadata may be obtained from human subjects, from the Internet, from the video clips themselves, etc. In step 615, a set of categories for categorizing the training set of videos are obtained. The known categories may be provided by one or more human subjects.

In step 620, a metadata-based categorization function is generated. In one example, to generate the metadata-based categorization function, the metadata may be sent to a text preprocessing stage, e.g., to remove stopwords, adjust capitalization, etc. Then, the metadata may be provided to a metadata-based learning engine. The metadata-based learning engine may use learning techniques, e.g., a Naive Bayes algorithm, Maximum Entropy algorithm, or a Support Vector Machine algorithm, to generate the metadata-based categorization function using the metadata and metadata features (which may be provided to the metadata-based learning engine or determined by the metadata-based learning engine).

In step 625, a content-based categorization function is generated. In one example, to generate the content-based categorization function, individual keyframes may be first obtained from the videos. Then, features of the keyframes can be extracted, e.g., using a feature extraction component 145. Then, the keyframe features may be provided to a content-based learning engine. The content-based learning engine may use learning techniques, e.g., a Naive Bayes algorithm, Maximum Entropy algorithm, or a Support Vector Machine algorithm, to generate a content-based categorization function using the keyframe features (which may be provided to the content-based learning engine or determined by the content-based learning engine).

In step 630, a fusion model is generated to blend the categorizations determined by the metadata-based categorization function and the content-based categorization function. The fusion model may be generated using a query profile matrix QP learned by our developed algorithm described above. Weightings may be given based on the particular category. Method 600 then ends.

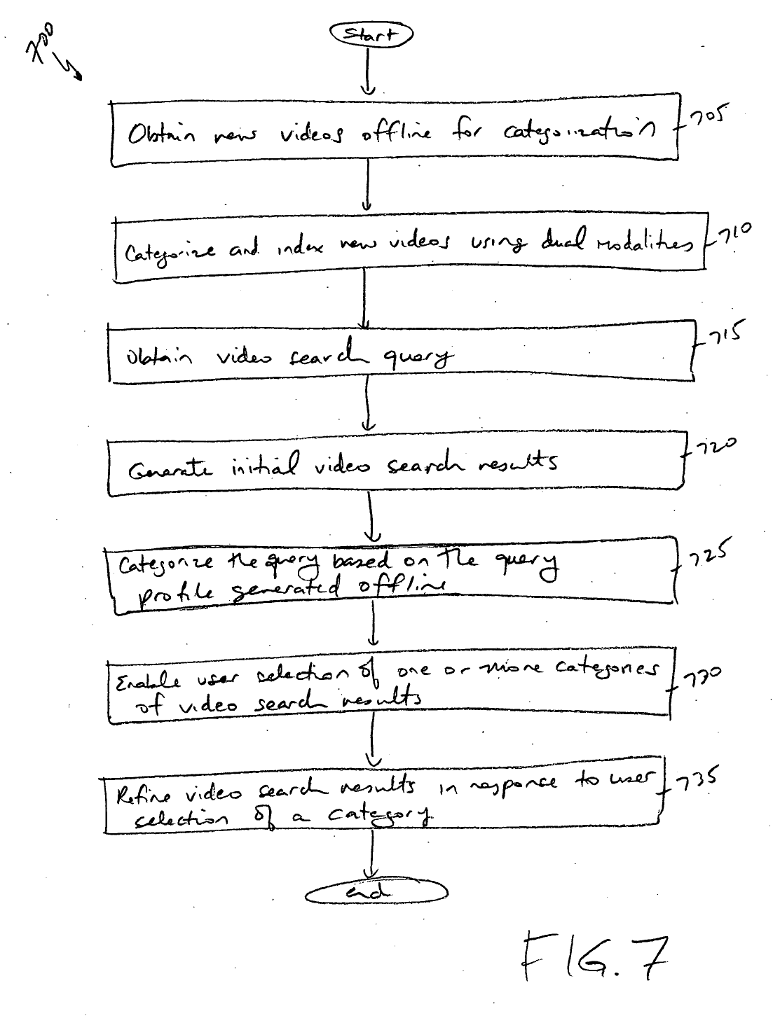

FIG. 7 is a flowchart illustrating a method 700 of indexing and searching a video database using dual modalities and possibly query profiling, in accordance with an embodiment of the present invention. Method 700 begins in step 705 with the obtaining of new video clips for categorization and indexing. The obtaining may be implemented by a web crawler, e.g., web crawler 205, operating offline. In step 710, the video clips are categorized using dual modalities and indexed. The categorization may be implemented by a dual modality categorization model 170, e.g., a metadata-based video classification model 160 and a content-based video classification model 165, and a fusion model 175 for blending the dual modality categorizations by the dual modality categorization model 170. The indexing may be implemented by an index building component, e.g., index building component 225.

In step 715, the video search engine 240 receives a video search query. In step 720, initial video search results are generated based on the search query. The initial video search results may be generated by a video search component on the video search engine, e.g., video search component 275 on video search engine 240. The initial search results may be based on conventional relevance function technology, which may ignore the indexed video categorization information. In step 725, in accordance with one embodiment of the present invention, the video search engine 240 categorizes the video search query based on the query profile generated offline (e.g., identifying the categories to which the query belongs). The query profile may be based on the users' query log or popular queries and the click history.

In step 730, the video search results and one or more categories of the video search results may be presented to the user, e.g., by the video search engine 240. The categories enabled for selection may be determined based on the query profile, based on the categories available in the result set, based on both, etc. In step 735, the video search results may be refined based on user selection of a particular category. Refinement of the video search results may be implemented by the search component 275 of the video search engine 240. Method 700 then ends.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
generating a first classification model for determining whether a video belongs to a category;
generating a second classification model for determining whether the video belongs to the category, the first classification model being based on a different modality than the second classification model; and
generating a fusion model that uses the results of the first classification model and the second classification model for determining whether the video belongs to the category.

2. The method of claim 1, wherein the first classification model includes a metadata-based classification model.

3. The method of claim 1, wherein the second classification model includes a content-based classification model.

4. The method of claim 3, wherein the generating the second classification model includes extracting a keyframe from the video clip and extracting visual features from the keyframe.

5. The method of claim 1, wherein each of the steps of generating a classification model uses statistical pattern learning.

6. The method of claim 1, wherein the step of generating a fusion model uses query profiles generated by a learning algorithm using users' query logs and click history data.

7. A system comprising:
a first learning engine for generating a first classification model for determining whether a video belongs to a category;
a second leaning engine for generating a second classification model for determining whether the video belongs to the category, the first classification model being based on a different modality than the second classification model; and
a third learning engine for generating a fusion model that uses the results of the first classification model and the second classification model for determining whether the video belongs to the category.

8. The system of claim 7, wherein the first classification model includes a metadata-based classification model.

9. The system of claim 7, wherein the second classification model includes a content-based classification model.

10. The system of claim 9, further comprising
a video analysis component for extracting a keyframe from the video clip; and
a feature extraction component for extracting visual features from the keyframe.

11. The system of claim 7, wherein each of the first and second learning engines uses statistical pattern learning.

12. The system of claim 7, wherein the third learning engine uses query profiles generated by a learning algorithm using users' query logs and click history data.

13. A method comprising:
obtaining a video clip;
using a first classification model to determine whether the video belongs to a category;
using a second classification model to determine whether the video belongs to the category, the first classification model being based on a different modality than the second classification model;
using a fusion model that uses the results of the first classification model and the second classification model to determine whether the video clip belongs to the category; and
indexing the video based on the result of the fusion model in a video index.

14. The method of claim 13, wherein the first classification model includes a metadata-based classification model.

15. The method of claim 13, wherein the second classification model includes a content-based classification model.

16. The method of claim 13, wherein the step of generating a fusion model uses query profiles generated by a learning algorithm using users' query logs and click history data.

17. The method of claim 15, further comprising extracting a keyframe from the video clip and extracting visual features from the keyframe.

18. The method of claim 13, further comprising generating video search results in response to a query and enabling selection of a category corresponding to the query.

19. The method of claim 18, wherein the category is identified from the possible categories of a subset of the video search results.

20. The method of claim 18, wherein the category is identified based on a query profile associated with the query.

21. The method of claim 20, wherein the query profile is determined based on users' query logs and click history.

22. The method of claim 20, wherein the query profile is determined based on popular queries and click history.

23. A system comprising:
a first classification model for determining whether a video clip belongs to a category;
a second classification model for determining whether the video clip belongs to the category, the first classification model being based on a different modality than the second classification model;
a fusion model that uses the results of the first classification model and the second classification model for determining whether the video belongs to the category; and
an index building component for indexing the video based on the result of the fusion model in a video index.

24. The system of claim 23, wherein the first classification model includes a metadata-based classification model.

25. The system of claim 23, wherein the second classification model includes a content-based classification model.

26. The system of claim 25, further comprising a video analysis component for extracting a keyframe from the video; and
a feature extraction component for extracting visual features from the keyframe.

27. The system of claim 23, further comprising a video search engine for generating video search results in response to a query and enabling selection of a category corresponding to the query.

28. The system of claim 27, wherein the video search engine identifies the category from the possible categories of a subset of the video search results.

29. The system of claim 27, wherein the video search engine identifies the category based on a query profile associated with the query.

30. The system of claim 29, wherein the video search engine determines the query profile based on users' query logs and click history.

31. The system of claim 29, wherein the video search engine determines the query profile based on popular queries and click history.
